(19) United States
(12) Patent Application Publication
(10) Pub. No.: US 2018/0276610 A1
(43) Pub. Date: Sep. 27, 2018

(54) RFID AS EXTRA VERIFICATION FOR HOME DELIVERY

(71) Applicant: CA, Inc., New York, NY (US)

(72) Inventors: Yashwant Ramkishan SAWANT, Parbhani (IN); Sandeep BANISETTI, Srikakulam (IN); Mohammed Mujeeb KALADGI, Bangalore (IN); Junaid Ahmed JAMEEL, Bangalore (IN)

(73) Assignee: CA, Inc., New York, NY (US)

(21) Appl. No.: 15/469,734

(22) Filed: Mar. 27, 2017

(51) Int. Cl. G06Q 10/08; H04W 4/00; G06Q 30/06

(52) U.S. Cl. CPC G06Q 10/0833; H04W 4/02; G06Q 30/0625; H04W 4/008

(57) ABSTRACT

A method includes determining a number of matching signal signatures within (1) ambient signal information for an order location and (2) ambient signal information for a delivery location, wherein the ambient signal information comprises signal signatures that identify a plurality of signal emitters at each location. The method also includes determining whether the delivery location matches the order location based on the number of matching signal signatures. The method further includes transmitting a message to a delivery operator indicating whether the delivery location matches the order location.

### BACKGROUND

The present disclosure relates to the delivery of goods and services, and, more specifically, to systems and methods for synchronizing a location of a delivery device with a location of ordering device based on a location profile of the ordering device.

Online shopping is a form of electronic commerce in which consumers directly buy goods or services from a seller over the internet using a web browser. Consumers find a product of interest by visiting a website of a retailer or by searching among alternative vendors via a search engine. A typical online store enables the customer to browse the firm's range of products and services, view photos or images of the products, along with information about the product specifications, features and prices.

This business to consumer online shopping market often involves delivery of items or services to a requested location indicated in the online order. The requested location is usually indicated by an address and, in some cases a unit or apartment number. For example, a customer may submit a food order to a local restaurant through a web page or app in which the customer determines that they would prefer delivery. To indicate the location of delivery, the customer often enters an address that may be used by the restaurant in the delivery process. In some circumstances, restaurant delivery services may rely on third party Global Positioning System (GPS) or mapping service to locate the delivery location.

However, third party GPS and mapping services are often incapable of precision location, especially in urban areas. For example, a GPS locating service may be able to determine a position within a tolerance of several meters, but only in a horizontal direction. For high-rises in urban areas, GPS may not be of much use in the vertical plane.

Systems and methods described herein may receive from an ordering device a location profile indicating a position of the ordering device. The location profile may include ambient signal data received on the first mobile device, wherein ambient signal data may respectively originate from a respective one of a plurality of signal emitters within a reception range of the ordering device. Systems and methods described herein may compare the location profile from the ordering device to a location profile of a delivery device, to determine whether the delivery device is at the precise location indicated by the location profile of the ordering device.

### BRIEF SUMMARY

According to an aspect of the present disclosure, a method may include several processes. In particular, the method may include receiving, from a first mobile device, a first location profile indicating a position of the first mobile device, the first location profile comprising first ambient signal data received on the first mobile device, wherein first ambient signal data originates from a respective one of a plurality of first signal emitters within a reception range of the first mobile device. The method may also include receiving a second location profile from a second mobile device, the second location profile comprising second ambient signal data received on the second mobile device, wherein second ambient signal data originates from a respective one of a plurality of second signal emitters within a reception range of the second mobile device. The method may also include comparing, using one or more processors, the first ambient signal data and the second ambient signal data, and determining whether the second mobile device is located within a predetermined distance of the position of the first mobile device based on the comparison.

Other features and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements of a non-limiting embodiment of the present disclosure.

FIG. 1 is a schematic representation of a management system ecosystem in a non-limiting embodiment of the present disclosure.

FIG. 2 is a schematic representation of a management system configured to interact with the management system ecosystem.

FIG. 3 illustrates functionality of a management system according to a non-limiting embodiment of the present disclosure.

FIG. 4 is a flow chart depicting authorization steps performed by a management system according to a non-limiting embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Each activity in the present disclosure may be executed on one, some, or all of one or more processors. In some non-limiting embodiments of the present disclosure, different activities may be executed on different processors.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to delivery systems, systems and methods disclosed herein may be related to any field involving correspondence or communication. Moreover, certain examples disclosed herein may be described with respect to consumer or business solutions, or any other field that may involve communication. Certain embodiments described in the present disclosure are merely provided as example implementations of the processes described herein.

Delivery services strive to provide users with timely and accurate deliveries without requiring any further information or contact from the customer. However, customers are often burdened with additional communications and requested to provide additional instructions to delivery services to complete delivery.

Systems and methods disclosed herein aim to increase the accuracy of delivery services through the use of additional information collected from the customer's ordering device during the ordering process. Systems and methods disclosed herein may receive, from a first mobile device, a first location profile indicating a position of the first mobile device, the first location profile comprising first ambient signal data received on the first mobile device, wherein first ambient signal data originates from a respective one of a plurality of first signal emitters within a reception range of the first mobile device. Systems and methods disclosed herein may also receive a second location profile from a second mobile device, the second location profile comprising second ambient signal data received on the second mobile device, wherein second ambient signal data originates from a respective one of a plurality of second signal emitters within a reception range of the second mobile device. Systems and methods disclosed herein may compare, using one or more processors, the first ambient signal data and the second ambient signal data, and determine whether the second mobile device is located within a predetermined distance of the position of the first mobile device based on the comparison.

The teachings of the present disclosure may reference specific example “device.” For example, a “device” may refer to a smartphone, tablet, desktop computer, laptop, Global Positioning System (GPS) device, satellite communication terminal, radio communication terminal, or any other device capable of communications. For example, a mobile device may be equipped with an application capable of communicating with an email system. Any device with such capabilities is contemplated within the scope of the present disclosure.

In a first example, systems and methods disclosed herein may receive, from a first mobile device, a first location profile indicating a position of the first mobile device, the first location profile comprising first ambient signal data received on the first mobile device, wherein first ambient signal data originates from a respective one of a plurality of first signal emitters within a reception range of the first mobile device. Systems and methods disclosed herein may receive a second location profile from a second mobile device, the second location profile comprising second ambient signal data received on the second mobile device, wherein second ambient signal data originates from a respective one of a plurality of second signal emitters within a reception range of the second mobile device. Systems and methods disclosed herein may compare, using one or more processors, the first ambient signal data and the second ambient signal data, and determine whether the second mobile device is located within a predetermined distance of the position of the first mobile device based on the comparison.

In a second example, systems and methods disclosed herein may receive, from a first mobile device, a request for a delivery to a position of the first mobile device and a first location profile indicating the position of the first mobile device, the first location profile comprising first ambient signal data received on the first mobile device, wherein first ambient signal data originates from a respective one of a plurality of first signal emitters within a reception range of the first mobile device. Systems and methods disclosed herein may receive a second location profile from a second mobile device, the second location profile comprising second ambient signal data received on the second mobile device, wherein second ambient signal data originates from a respective one of a plurality of second signal emitters within a reception range of the second mobile device. Systems and methods disclosed herein may compare the first ambient signal data and the second ambient signal data, and determine whether the second mobile device is located within a predetermined distance of the position of the first mobile device based on the comparison.

In a third example, systems and methods disclosed herein may receive, from a first mobile device, a first location profile indicating a position of the first mobile device, the first location profile comprising first global positioning data and first ambient signal data received on the first mobile device, wherein first ambient signal data originates from a respective one of a plurality of first signal emitters within a reception range of the first mobile device, and wherein first ambient signal data comprise signal strength data from the respective one of the plurality of first signal emitters. Systems and methods disclosed herein may receive a second location profile from a second mobile device, the second location profile comprising second global positioning data and second ambient signal data received on the second mobile device, wherein second ambient signal data originates from a respective one of a plurality of second signal emitters within a reception range of the second mobile device. Systems and methods disclosed herein may compare, using one or more processors, the first ambient signal data and the second ambient signal data, and determine whether the second mobile device is located within a predetermined distance of the position of the first mobile device based on the comparison.

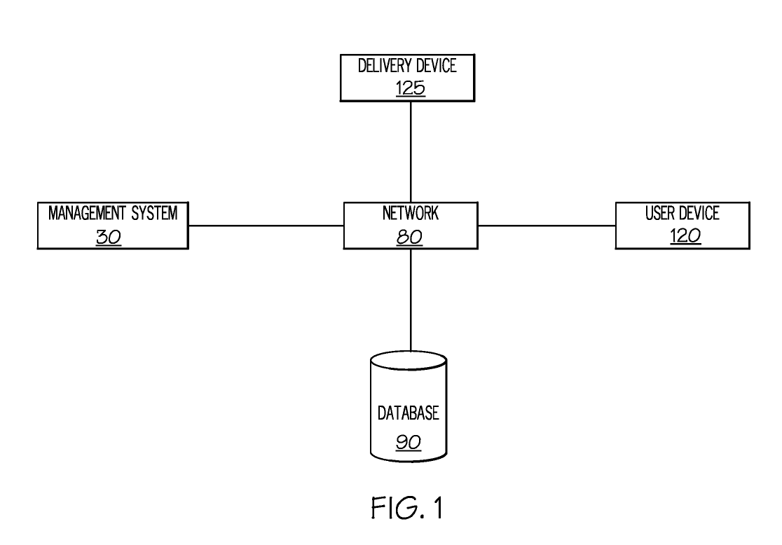

FIG. 1 is a schematic representation of a management system ecosystem in a non-limiting embodiment of the present disclosure. A management system 30 may communicate with a database 90 and user device 120 via a network 80. In some non-limiting embodiments of the present disclosure, management system 30 may directly communicate with user device 120 if management system 30 is installed on the user device 120. Further, management system 30 may communicate with a local database 95. User device 120 may be a mobile device with an email application capable of communicating with management system 30. In some non-limiting embodiments, management system 30 may be installed on the user device 120 as, for example, a plug-in. In some non-limiting embodiments, management system 30 may be a plug-in for an email application or a mobile application on a user's mobile device.

Network 80 may comprise one or more entities, which may be public, private, or community based. Network 80 may permit the exchange of information and services among users/entities that are connected to such network 80. In certain configurations, network 80 may be a local area network, such as an intranet. Further, network 80 may be a closed and/or private network/cloud in certain configurations, and an open network/cloud in other configurations. Network 80 may facilitate wired or wireless communications of information and provisioning of services among users that are connected to network 80.

Network 80 may comprise one or more clouds, which may be public clouds, private clouds, or community clouds. Each cloud may permit the exchange of information and the provisioning of services among devices and/or applications that are connected to such clouds. Network 80 may include a wide area network, such as the Internet; a local area network, such as an intranet; a cellular network, such as a network using CDMA, GSM, 3G, 4G, LTE, or other protocols; a machine-to-machine network, such as a network using the MQTT protocol; another type of network; or some combination of the aforementioned networks. Network 80 may be a closed, private network, an open network, or some combination thereof and may facilitate wired or wireless communications of information among devices and/or applications connected thereto.

Network 80 may include a plurality of devices, which may be physical devices, virtual devices (e.g., applications running on physical devices that function similarly to one or more physical device), or some combination thereof. The devices within network 80 may include, for example, one or more of general purpose computing devices, specialized computing devices, mobile devices, wired devices, wireless devices, passive devices, routers, switches, mainframe devices, monitoring devices, infrastructure devices, other devices configured to provide information to and/or receive information from service providers and users, and software implementations of such.

In some non-limiting embodiments of the present disclosure, user device 120 may be any type of computer such as, for example, a desktop computer. In other non-limiting embodiments, user device 120 may be a mobile device such as a mobile phone, laptop, tablet, any portable device, etc. Mobile electronic devices may be part of a communication network such as a local area network, wide area network, cellular network, the Internet, or any other suitable network. Mobile devices may be powered by a mobile operating system, such as Apple Inc.'s iOS® mobile operating system or Google Inc.'s Android® mobile operating system, for example. A mobile electronic device may use a communication network to communicate with other electronic devices, for example, to access remotely-stored data, access remote processing power, access remote displays, provide locally-stored data, provide local processing power, or provide access to local displays. For example, networks may provide communication paths and links to servers, which may host email applications, content, and services that may be accessed or utilized by users via mobile electronic devices. The content may include text, video data, audio data, user settings or other types of data. Networks may use any suitable communication protocol or technology to facilitate communication between mobile electronic devices, such as, for example, BLUETOOTH, IEEE WI-FI (802.11a/b/g/n/ac), or Transmission Control Protocol/Internet Protocol (TCP/IP).

In some non-limiting embodiments management system 30 may use network 80 to communicate with user device 120. In other non-limiting embodiments of the present disclosure, management system 30 may be installed on the user device 120. Management system 30 may be fully installed on the user device 120 and work in tandem with an ordering application or website on the user device 120. In some non-limiting embodiments of the present disclosure, management system 30 may support communications between the user device 120 and another device. In some non-limiting embodiments, user device 120 may represent a plurality of user devices such as, for example, laptops and mobile cellular telephones. In addition, a user may have a plurality of user accounts on each user device 120. Management system 30 may interact with any of a plurality of user accounts for each user.

The management system 30 environment may also include a database 90. Database 90 may include, for example, additional servers, data storage, and resources. Management system 30 may receive from database 90 additional data, user account information, user correspondence history and preferences, contact information, or any data used by management system 30. Database 90 may be any conventional database or data infrastructure. For example, database 90 may include scaled out data architectures (i.e., Apache Hadoop) and/or persistent, immutable stores/logging systems.

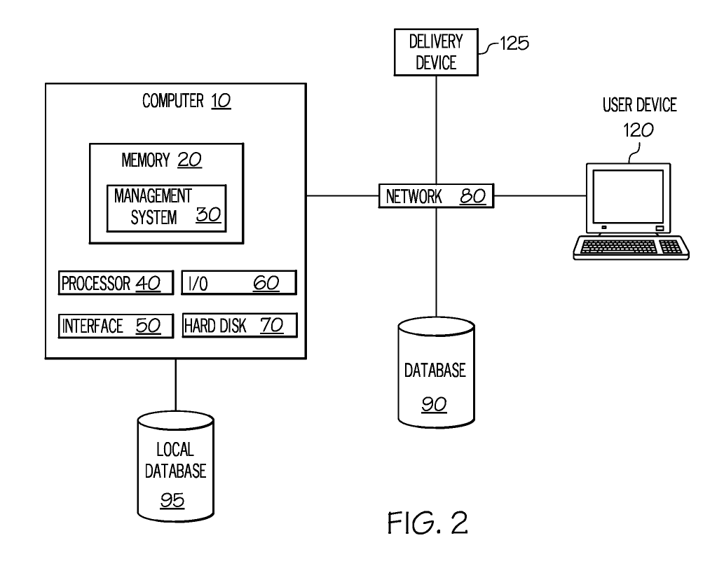

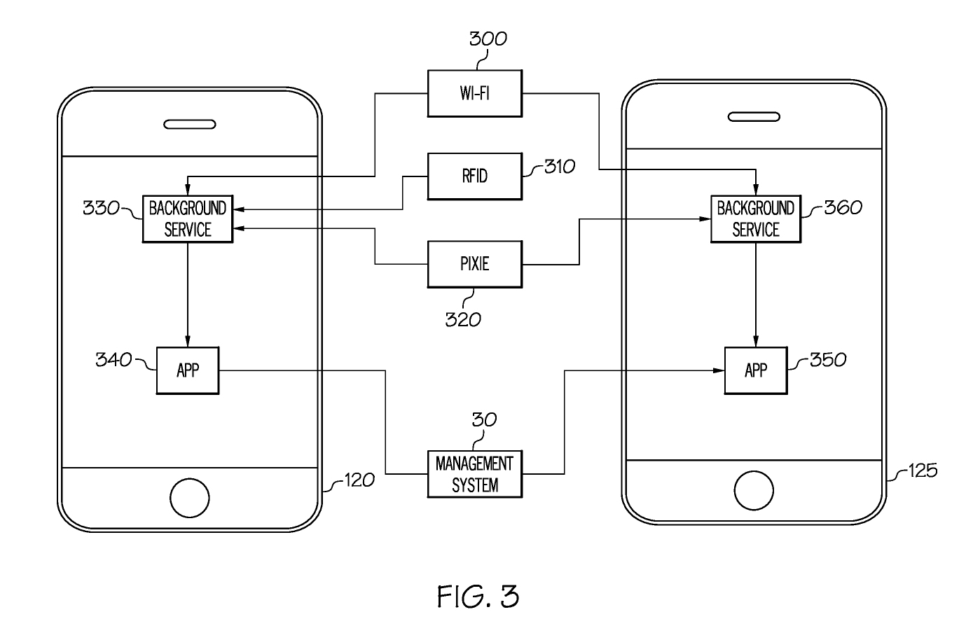

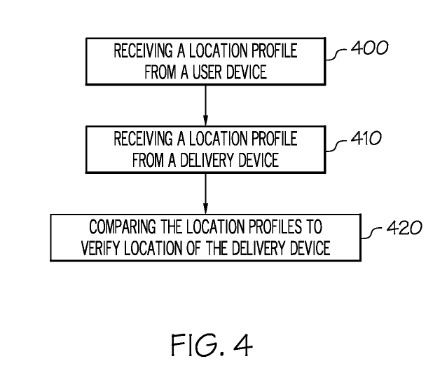

FIG. 2 displays the management system 30 of a non-limiting embodiment of the present disclosure. Computer 10 may reside on one or more networks. In some non-limiting embodiments, computer 10 may be located on any device that may receive input from a device, such as, for example, a mobile device or user device 120. Computer 10 may comprise a memory 20, a central processing unit, an input and output (“I/O”) device 60, a processor 40, an interface 50, and a hard disk 70. Memory 20 may store computer-readable instructions that may instruct computer 10 to perform certain processes. In particular, memory 20 may store a plurality of application programs that are under development. Memory 20 also may store a plurality of scripts that include one or more testing processes for evaluation of applications or input. When computer-readable instructions, such as an application program or a script, are executed by the CPU, the computer-readable instructions stored in memory 20 may instruct the CPU or management system 30 to perform a plurality of functions. Examples of such functions are described below with respect to FIGS. 3-4.

In some non-limiting embodiments of the present disclosure, the CPU may be management system 30. In some implementations, when computer-readable instructions, such as an application program or a script, are executed by the CPU, the computer-readable instructions stored in memory 20 may instruct the management system 30 to interact with user device 120. Computer 10 may be located on the user device 120, on a remote server, on the cloud, or any combination thereof. In some non-limiting embodiments, Computer 10 and management system 30 may communicate with user device 120 via network 80. In some non-limiting embodiments, management system 30 may interact with an email application on the computer 10 to communicate with other devices, such as user device 120. In some non-limiting embodiments, management system 30 may be located on the user device 120.

I/O device 60 may receive data from network 80, database 90, local database 95, data from other devices and sensors connected to management system 30, and input from a user and provide such information to the management system 30. I/O device 60 may transmit data to network 80, database 90, and/or local database 95. I/O device 60 may transmit data to other devices connected to management system 30, and may transmit information to a user (e.g., display the information, send an e-mail, make a sound) or transmit information formatted for display on a user device 120 or any other device associated with the user. Further, I/O device 60 may implement one or more of wireless and wired communication between user device 120 or management system 30 and other devices within or external to network 80. I/O device 60 may receive one or more of data from another server or a network 80. The management system 30 may be a processing system, a server, a plurality of servers, or any combination thereof. In addition, I/O device 60 may communicate received input or data from user device 120 to management system 30.

Management system 30 may be located on the cloud, on an external network, on user device 120, or any combination thereof. Management system 30 may be SaaS or entirely located on the user device 120. Furthermore, some non-limiting configurations of management system 30 may be located exclusively on a user device 120, such as, for example, a mobile device or tablet. Management system 30 may also be accessed and configured by a user on user device 120 or any other graphical user interface with access to management system 30. In some non-limiting embodiments, the user may connect to network 80 to access management system 30 using the user device 120.

Further referring to FIG. 2, in some non-limiting embodiments of the present disclosure, a mobile application may be installed on the user device 120. The mobile application may facilitate communication with management system 30, database 90, local database 95, an email application on user device 120, or any other entity. In some non-limiting embodiments, a program on user device 120 may track, record, and report input information to the management system 30, such as, for example, past interactions, login dates and times, delivery requests and corresponding signal data, previous location profiles, user configurations, and corresponding data. In systems and methods of the present disclosure, such as when the management system 30 is located on user device 120, user device 120 may not be connected to network 80 while in communication with management system 30.

In some non-limiting embodiments, user device 120 may store data, user preferences and configurations, and any other data associated with the management system 30 locally on the user device 120. In some non-limiting embodiments of the present disclosure, an application on the user device 120 may communicate with management system 30 to manage communications, data, and corresponding user input or requests on the user device 120. User device 120 may have a user interface for the user to communicate with management system 30. An application on the user device 120 and management system 30 may maintain an offline copy of all information. In some non-limiting embodiments of the present disclosure, in which the management system 30 is located partially or completely on user device 120, management system 30 may facilitate communications regarding email communications with other devices. Management system 30 may also facilitate communications between users via SMS protocol, messaging applications on any device, or any other application used for communication. Management system 30 may rely on information stored locally on user device 120. User may store communication preferences, such as a preferred delivery information and signal data, on the user device 120. In some systems and methods of the present disclosure, management system 30 may rely on information such as user preferences and configurations in a cloud database.

FIG. 3 illustrates functionality of a management system according to a non-limiting embodiment of the present disclosure. A use device 120 may place an order with a delivery service on a website or via a delivery application 340. A background service 330 on the user device 120 may receive all signals within range of the user device 120. For example, the background service 330 may receive WI-FI signals 300, RFID signals 310, Pixie signals 320, as well as BLUETOOTH signals, radio signals, cell signals, and any other type of signal. Background service 330 may also recognize any hardware tags. In some non-limiting embodiments, background service 330 may include or utilize a portion of hardware within user device 120. Background service 330 may receive signal continuously or only when the user device 120 is used for online shopping or placing an online delivery request.

Background service 330 may develop a location profile with ambient signal data received on the user device 120. In some non-limiting embodiments, background service 330 is located on the cloud. In other non-limiting embodiments, background service 330 is an application located on the user device 120. Ambient signal data may include signal data from a plurality of devices emitting signal within range of the user device 120. In addition to type of signal, background service 330 may determine the strength of each ambient signal. Such information may assist a delivery service in locating a requested delivery location for an item or service. The location profile determined by background service 330 may contain all ambient signal data. Location profiles may contain any data received or located on a device. Such data may include, for example, GPS data or IP address data. Further, location profiles may include hardware tags with which the user device 120 is within contact. In some non-limiting embodiments, location profiles may include historical location information and data associated with previous communications or previously signal data received by the user device 120. In some non-limiting embodiments, a user device 120 may indicate a previous location profile for delivery if the user device 120 is not located in the preferred delivery location. In some cases, user device 120 may indicate a location profile different device for a delivery location.

After determining the location profile, background service 330 may transmit the location profile to an ordering application 340. In some non-limiting embodiments, the ordering application 340 may be associated with a specific delivery service. The ordering application 340 may also be located on a website. The ordering app 340 receives an order from a user using user device 120. Upon ordering, the ordering app 340 sends a location profile to management system 30. In some non-limiting embodiments, management system 30 may also receive the order details from ordering app 340. Order details may include the good or service requested, payment details, address details, specific order instructions, or any other order information.

Management system 30 may communicate the location profile to a delivery application 350 on delivery device 125. Delivery device 125 may be used as a navigational tool for delivery of an ordered good or service. In addition to third party GPS applications, delivery application 350 may use the location profile determined by background service 330 in order to precisely locate the position from which the user device 120 requested delivery.

Delivery device 125 may have a background service 360 that acts in a similar manner and with similar features as background service 330. Background service 360 on delivery device 125 may receive all signals within range of the delivery device 125. For example, the background service 360 may receive WI-FI signals 300, RFID signals 310, Pixie signals 320, as well as BLUETOOTH signals, radio signals, IBecon signals, cell signals, and any other type of signal. Background service 360 may also recognize any hardware tags. In some non-limiting embodiments, background service 360 may include or utilize a portion of hardware within user device 125. Background service 360 may receive signal continuously or only when the delivery device 125 is near the delivery location.

Delivery device 125 may compare ambient signal data from background service 360 to the location profile received on the delivery application 350 from management system 30. Background service 360 may compare strength of received signals and signal type to the location profile of user device 120. Through this comparison, background service 360 may be able to determine with precision whether the location of delivery device 125 is close to the location of the user device 120 when the user device 120 requested delivery. In some non-limiting embodiments, background service 360 may be located on the cloud. In some non-limiting embodiments, comparison of the location profile to received signal data by background service 360 may be completed by management system 30.

Management system 30 may, in some non-limiting embodiments, be associated with a website. In some non-limiting embodiments, a user may register a user ID or username along with a password on the website associated with management system 30. In some non-limiting embodiments, the password is a one-time password. In addition to login information, the user may designate a location and a location profile to associate with the account. Users may designate multiple location profiles associated with respective preferred delivery locations.

FIG. 4 is a flow chart depicting authorization steps performed by a management system according to a non-limiting embodiment of the present disclosure. In step 400, management system 30 may receive a location profile from a user device 120. The location profile may indicate a position of the user device 120 by including ambient signal data received on the user device 120. The ambient signal data may include signal data and strength from signal emitters within a range of the user device 120. In some non-limiting embodiments, the ambient signal data may be a snapshot of signal data at the time of placing a delivery order from the user device 120.

In step 410, management system 30 may receive a delivery profile from a delivery device 125. The delivery profile may indicate a position of the delivery device 125 by including ambient signal data received on the delivery device 125. The ambient signal data may include signal data and strength from signal emitters within a range of the delivery device 125. In some non-limiting embodiments, the ambient signal data may be a snapshot of signal data at the time of delivering a delivery order from the delivery device 125.

In step 420, management system 30 may continuously compare the ambient signal data received on the delivery device 125 to the location profile submitted by the user device 120. This comparison may indicate by threshold measurement the proximity of the delivery device 125 to the location of the user device 120 at the time of ordering. In some non-limiting embodiments, due to the variability of ambient signals, management system 30 may indicate to the delivery device 125 that they are in the correct location based on a predetermined percentage overlap with the original location profile. For example, if the location profile received on the delivery device 125 matches according to a predetermined percentage, such as 80%, with the location profile submitted by the user device 120, management system 30 may indicate to the user of the delivery device 125 that they are in the correct location for delivery. Management system 30 may determine, based on the comparison, whether similarities between ambient signal data of the user device 120 and ambient signal data of the delivery device 125 meet a predetermined threshold.

In some non-limiting embodiments, management system 30 may format for display and display a mapping indicating the location of the delivery device 125 and a directional indication notifying a user of the delivery device 125 to head in a certain direction to increase the overlap between the original location profile and the location profile generated by the delivery device 125. In some non-limiting embodiments, the location profile of the delivery device 125 may be in constant fluctuation and be constantly compared to the location profile submitted by the user device 120. By comparing the ambient signal data from the user device 120 to the ambient signal data of the delivery device 125, management system 30 may determine whether the delivery device 125 is located within a predetermined distance of the position of the user device 120 upon ordering. In some non-limiting embodiments, the location profile of the user device 120 may be flexible and refresh ambient signal data after submitting a delivery request. For example, delivery device 125 may request a refresh of the location profile of the user device 120 closer to the time of delivery in order to more accurately pinpoint the correct location using the management system 30.

In some non-limiting embodiments, management system 30 may determine a location map based on the location profile of the user device 120. Management system may format for display the location map based on the first location profile and transmit the location profile and the location map to the delivery device 125. Management system 30 may also, in some cases, rely on additional data from third party GPS and mapping providers in order to more precisely pinpoint location for the delivery device 125. In some non-limiting embodiments, management system 30 may, in determining the location map, receive a plurality of complimentary location profiles respectively from a plurality of devices, each complimentary location profile respectively comprising signal data originating from at least one of the plurality of signal emitters. Management system 30 may determine the location map based on the plurality of complimentary location profiles. Complimentary location profiles may be received by management system 30 from any type of device, including mobile devices. In some cases, complimentary location profiles may include ambient signal data of signal emitters that overlap with signal emitters indicated in the location profile of the user device 120.

Management system 30 may also track and store data regarding user communications. For example, management system 30 may track and store communications with a plurality of user devices as well as location profiles, ambient signal data, and any other data. In some non-limiting embodiments, management system 30 may register a plurality of user devices for a single user account. Management system 30 may communicate with a user on any of the user devices associated with the user account. Data may be stored on local database 95, database 90, on computer 10, on user device 120, in the cloud, or in any other manner.

The flowcharts and diagrams in FIGS. 1-4 illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, “each” means “each and every” or “each of a subset of every,” unless context clearly indicates otherwise.

The corresponding structures, materials, acts, and equivalents of means or step plus function elements in the claims below are intended to comprise any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. For example, this disclosure comprises possible combinations of the various elements and features disclosed herein, and the particular elements and features presented in the claims and disclosed above may be combined with each other in other ways within the scope of the application, such that the application should be recognized as also directed to other embodiments comprising other possible combinations. The aspects of the disclosure herein were chosen and described in order to best explain the principles of the disclosure and the practical application and to enable others of ordinary skill in the art to understand the disclosure with various modifications as are suited to the particular use contemplated.

What is claimed is:

1. A method comprising:
determining, by one or more processors, a number of matching signal signatures within (1) ambient signal information for an order location and (2) ambient signal information for a delivery location, wherein the ambient signal information comprises signal signatures that identify a plurality of signal emitters at each location;
determining, by the one or more processors, whether the delivery location matches the order location based on the number of matching signal signatures; and
transmitting a message to a delivery operator indicating whether the delivery location matches the order location.

2. The method of claim 1,
wherein the ambient signal information for the order location is received from a first device used to place an order associated with the order location, and
wherein the ambient signal information for the delivery location is received from a second device associated with the delivery operator at the delivery location.

3. The method of claim 1, further comprising:
determining a relative strength of each of the signal signatures within the ambient signal information for the order location; and
generating a delivery map indicative of a desired delivery location based on the relative strength of each of the signal signatures.

4. The method of claim 1, further comprising:
determining whether the location is within a predetermined distance of the order location based on whether differences in characteristics of the ambient signal information for the order location and delivery location are within a predetermined threshold.

5. The method of claim 1, wherein the ambient signal information for an order location is retrieved from a database of stored ambient signal information in response to a user input while placing an associated order.

6. The method of claim 5, wherein the order location is different from a current location of the user when placing the associated order.

7. The method of claim 1, further comprising
verifying the delivery location using global positioning data associated with the delivery operator.

8. The method of claim 1, wherein the ambient signal information comprises a WI-FI signal.

9. The method of claim 1, wherein the ambient signal information comprises a signal received from an RFID tag that is received in response to an interrogating frequency transmitted by a device placing an order for delivery at the delivery location.

10. The method of claim 1, wherein the ambient signal information comprises a signal strength of a BLUETOOTH signal.

11. A computer configured to access a storage device, the computer comprising:
a processor; and
a non-transitory, computer-readable storage medium storing computer-readable instructions that when executed by the processor cause the computer to perform:
determining, by one or more processors, a number of matching signal signatures within (1) ambient signal information for an order location and (2) ambient signal information for a delivery location, wherein the ambient signal information comprises signal signatures that identify a plurality of signal emitters at each location;
determining, by the one or more processors, whether the delivery location matches the order location based on the number of matching signal signatures; and
transmitting a message to a delivery operator indicating whether the delivery location matches the order location.

12. The computer of claim 11,
wherein the ambient signal information for the order location is received from a first device used to place an order associated with the order location, and
wherein the ambient signal information for the delivery location is received from a second device associated with the delivery operator at the delivery location.

13. The computer of claim 11, further comprising:
determining a relative strength of each of the signal signatures within the ambient signal information for the order location; and
generating a delivery map indicative of a desired delivery location based on the relative strength of each of the signal signatures.

14. The computer of claim 11, further comprising:
determining whether the location is within a predetermined distance of the order location based on whether differences in characteristics of the ambient signal information for the order location and delivery location are within a predetermined threshold.

15. The computer of claim 11, wherein the ambient signal information for an order location is retrieved from a database of stored ambient signal information in response to a user input while placing an associated order.

16. The computer of claim 15, wherein the order location is different from a current location of the user when placing the associated order.

17. The computer of claim 11, further comprising
verifying the delivery location using global positioning data associated with the delivery operator.

18. The computer of claim 11, wherein the ambient signal information comprises a WI-FI signal.

19. The computer of claim 11, wherein the ambient signal information comprises a signal received from an RFID tag that is received in response to an interrogating frequency transmitted by a device placing an order for delivery at the delivery location.

20. A non-transitory computer-readable medium having instructions stored thereon that is executable by a computing system to perform operations comprising:
determining, by one or more processors, a number of matching signal signatures within (1) ambient signal information for an order location and (2) ambient signal information for a delivery location, wherein the ambient signal information comprises signal signatures that identify a plurality of signal emitters at each location;
determining, by the one or more processors, whether the delivery location matches the order location based on the number of matching signal signatures; and
transmitting a message to a delivery operator indicating whether the delivery location matches the order location.
